(19) United States
(12) Patent Application Publication
(10) Pub. No.: US 2013/0315039 A1
(43) Pub. Date: Nov. 28, 2013

(54) METHOD FOR CONTROLLING WAKE-UP OF SOUND WAVE-BASED WIRELESS NETWORK AND WIRELESS SENSOR NETWORK USING THE SAME

(71) Applicant: KOREA ELECTRONICS TECHNOLOGY INSTITUTE, Seongnam-si (KR)

(72) Inventors: Il Yeup AHN, Namyangju-si (KR); Min Hwan SONG, Seoul (KR); Sang Shin LEE, Yongin-si (KR); Jae Ho KIM, Yongin-si (KR); Jae Seok YUN, Yongin-si (KR); Kwang Ho WON, Yongin-si (KR)

(73) Assignee: KOREA ELECTRONICS TECHNOLOGY INSTITUTE, Seongnam-si (KR)

(21) Appl. No.: 13/901,508

(22) Filed: May 23, 2013

(30) Foreign Application Priority Data
May 25, 2012 (KR) 10-2012-0056254
Jul. 20, 2012 (KR) 10-2012-0079292

(51) Int. Cl. G08C 23/02

(52) U.S. Cl. CPC G08C 23/02
USPC 367/197

(57) ABSTRACT

A method for controlling wake-up of a sound wave-based wireless network and a wireless sensor network using the same are provided. A wireless device constituting the wireless sensor network is woken up by receiving a sound wave from an external device and receives data, or wakes up an external device by transmitting a sound wave and transmits data. Since wake-up is controlled by a sound wave through a microphone and a speaker which consume less power, a time that an RF transceiver spends staying in a reception standby state is minimized and power consumption at a wireless sensor node is minimized.

### CROSS-REFERENCE TO RELATED APPLICATION

This application claims priority from Korean Patent Application No. 10-2012-0056254, filed on May 25, 2012 and Korean Patent Application No. 10-2012-0079292, filed on Jul. 20, 2012 in the Korean Intellectual Property Office, the disclosure of which is incorporated herein by reference in its entirety.

### BACKGROUND

1. Field

Methods and apparatuses consistent with exemplary embodiments relate to a wireless sensor network, and more particularly, to a method for controlling wake-up of wireless sensor nodes constituting a wireless sensor network, and a wireless sensor network using the same.

2. Description of the Related Art

In general, researches on media access control (MAC) of wireless sensor nodes in a wireless sensor network aim at providing wireless sensor nodes which can communicate with one another effectively, while being operated with low power.

Therefore, various types of MACs such as B-MAC, low power listening (LPL), S-MAC, and D-MAC have been announced, and all of them suggest a method in which nodes can switch between a sleep state and an active state and communicate with one another without wasting power when necessary.

After all, all problems arise from a long standby time that nodes spend prior to receiving packets during communications in a wireless sensor network. The results of researches so far conducted show that standby occupies 80% or more of total time required to communicate if whole communications of sensor nodes are divided into transmission, reception, and standby.

Therefore, there is a demand for a method for minimizing a time that wireless sensor nodes spend staying in a standby state.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a method for controlling wake-up using a sound wave, which can minimize power consummation at a wireless sensor node by reducing a standby time, and a wireless sensor network using the same.

According to an aspect of an exemplary embodiment, there is provided a wireless device including: a sound wave receiver which receives a sound wave output from a first external device, converts the sound wave into an electric sound signal, and outputs an interrupt, an RF transceiver which RF-communicates with the first external device, and a processor which, when the interrupt is received from the sound wave receiver in a sleep state, is woken up and receives data from the first external device through the RF transceiver.

The sound wave receiver may include: a microphone which receives the sound wave output from the first external device and converts the sound wave into a sound signal, an amplifier which amplifies the sound signal which is output from the microphone, and a filter which filters a specific frequency band from the sound signal amplified by the amplifier, and outputs the specific frequency band as an interrupt.

The specific frequency band may be a frequency band that is allocated to wake up the wireless device.

The wireless device may further include a sound wave transmitter which converts an input sound signal into a sound wave, and the processor may forward a sound signal of a frequency band to wake up a second external device, which is in a sleep state, to the sound wave transmitter, and, when the second external device is woken up, may transmit data to the second external device through the RF transceiver.

The wireless device may further include a sensor which generates data by sensing, and, when a sensing period arrives in a sleep state, the processor may generate sensing data by operating the sensor, may forward the sound signal to the sound wave transmitter, and may transmit the sensing data to the second external device through the RF transceiver.

The wireless device may further include a sensor which generates data by sensing, and, when the interrupt is received from the sound wave receiver, the processor may be woken up, generates sensing data by operating the sensor, may forward the sound signal to the sound wave transmitter, and may transmit the sensing data and the data received from the first external device to the second external device through the RF transceiver.

According to an aspect of another exemplary embodiment, there is provided a wireless device including: a sound waver transmitter which converts an input sound signal into a sound wave, and outputs the sound wave, an RF transceiver which RF-communicates with an external device, and a processor which forwards a sound signal of a specific frequency band to the sound wave transmitter to wake up the external device which is in a sleep state, and, when the external device is woken up, transmits data to the external device through the RF transceiver.

The specific frequency band may be a frequency band that is allocated to wake up the external device.

According to the exemplary embodiments described above, since wake-up is controlled by a sound wave through the microphone and the speaker which consume less power, a time that the RF transceiver spends staying in a reception standby state can be minimized and power consumption at the wireless sensor node can be minimized

Also, since a unique frequency band of a sound wave is allocated to each wireless sensor node, only a necessary wireless sensor node can be woken up and thus power consummation in the whole wireless sensor network can be minimized

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram illustrating a wireless sensor node according to an exemplary embodiment;

FIG. 2 is a flowchart to explain a process of receiving data at the wireless sensor node of FIGS. 1; and

FIG. 3 is a flowchart to explain a process of transmitting data at the wireless sensor node of FIG. 1.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

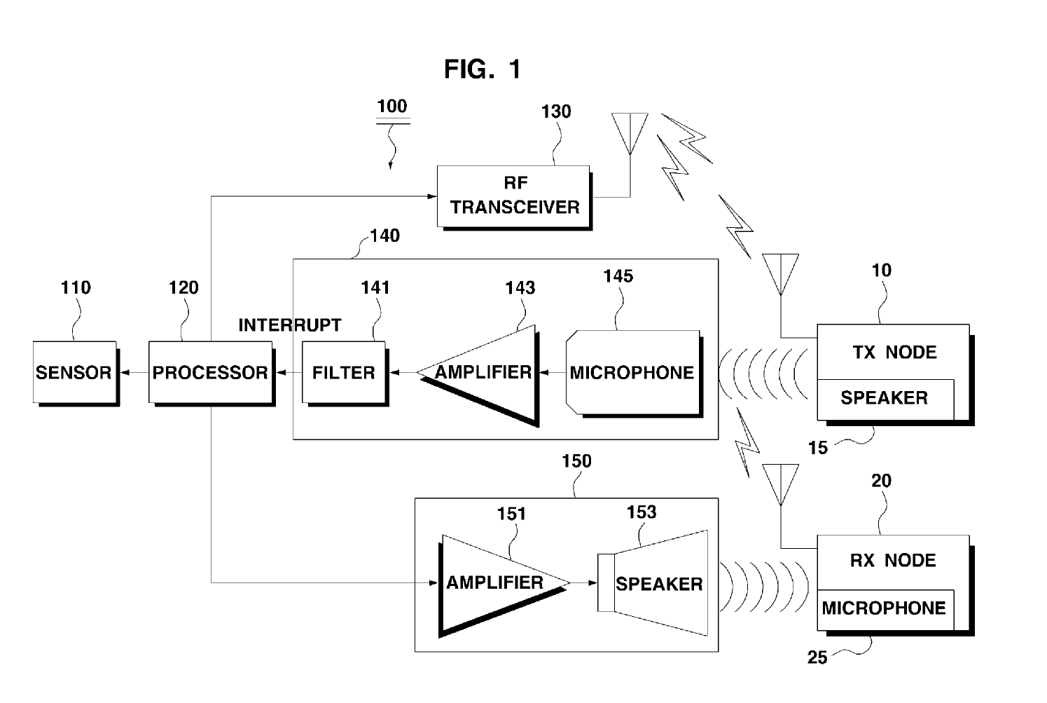

FIG. 1 is a block diagram illustrating a wireless sensor node according to an exemplary embodiment. The wireless sensor node 100 illustrated in FIG. 1 is a wireless device that constitutes a wireless sensor network.

For the sake of easy understanding and explanation, FIG. 1 further illustrates a Tx node 10 and a Rx node 20 besides the wireless sensor node 100. The Tx node 10 is a node that transmits data to the wireless sensor node 100, and the Rx node 20 is a node that receives data from the wireless sensor node 100.

As shown in FIG. 1, the wireless sensor node 100 includes a sensor 110, a processor 120, a radio frequency (RF) transceiver 130, a sound wave receiver 140, and a sound wave transmitter 150.

The sensor 110 generates data by sensing, and forwards the generated data to the processor 120.

The RF transceiver 130 is a means for exchanging data by RF-communicating with the Tx node 10 and the Rx node 20.

The sound wave receiver 140 receives a sound wave which is output from a speaker 15 of the transmission mode 10, and, if the received sound wave is a sound wave to wake up the wireless sensor node 100, generates an interrupt and forwards the interrupt to the processor 120. That is, the sound wave receiver 140 serves to trigger the processor 120.

The sound wave receiver 140, which performs such a function, includes a filter 141, an amplifier 143, and a microphone 145 as shown in FIG. 1. The filter 141, which is a passive element, does not consume power, and the amplifier 143 and the microphone 145 may be implemented by using small low power elements.

The microphone 145 receives the sound wave output from the speaker 15 of the Tx node 10 and converts the sound wave into an electric sound signal, the amplifier 143 amplifies the sound signal output from the microphone 145, and the filter 141 filters a specific frequency band from the amplified sound signal.

The frequency band filtered by the filter 141 is a unique frequency band that is allocated to the wireless sensor node 100. That is, the wireless sensor nodes constituting the wireless sensor network are allocated different frequency bands. This is to wake up only the wireless sensor node that should receive data by adjusting a sound frequency band.

Accordingly, the frequency band filtered by the filter 141 is a frequency band that has been allocated for wake up of the wireless sensor node 100. In order to wake up the wireless sensor node 100, the sound signal of the frequency band filtered by the filter 141 is output as a sound wave.

When the sound signal of the specific frequency band is filtered by the filter 141, the filtered sound signal is input to the processor 120 as an interrupt. That is, an interrupt may be generated when there is a sound signal filtered by the filter 141.

The sound wave transmitter 150 is a means for waking up the Rx node 20 by converting an input sound signal into a sound wave and outputting the sound wave to a microphone 25 of the Rx node 20. The sound wave transmitter 150, which performs such a function, includes an amplifier 151 and a speaker 153 as shown in FIG. 1. The amplifier 151 and the speaker 153 may be implemented by using small low power elements.

The amplifier 151 amplifies a sound signal which is input from the processor 120, and the speaker 153 converts the sound signal amplified by the amplifier 151 into a sound wave, and outputs the sound wave.

The processor 120 transmits the data which is generated by the sensor 110 to the Rx node 20 through the RF transceiver 130. Also, the processor 120 receives data from the Tx node 10 through the RF transceiver 130.

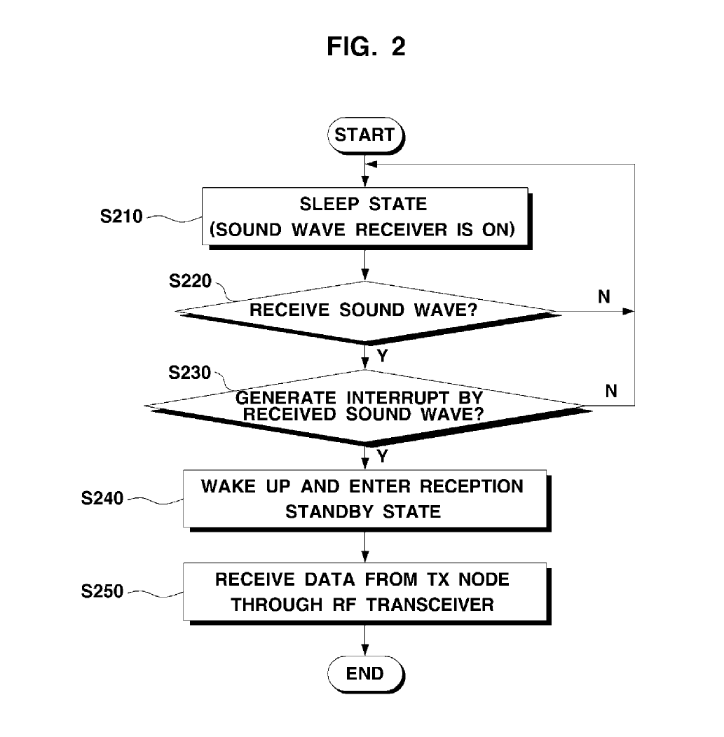

When the wireless sensor node 100 is operated in a sleep state, the wireless sensor node 100 is required to be woken up to receive data. The wireless sensor node 100 is woken up by the Tx node 10 outputting a sound wave to the sound wave receiver 140 of the wireless sensor node 100 using the speaker 10. Hereinafter, such a process of waking up the wireless sensor node 100 will be explained in detail with reference to FIG. 2.

FIG. 2 is a flowchart to explain a process of receiving data of the wireless sensor node 100 of FIG. 1.

As shown in FIG. 2, the wireless sensor node 100 may be operated in a sleep state in order to reduce consumption of a limited battery. In the sleep state, the sound wave receiver 140 of the wireless sensor node 100 is in an on state (S210). Also, a port of the processor 120 to receive an interrupt signal from the sound wave receiver 150 is open.

In such a sleep mode, when the microphone 145 of the sound wave receiver 140 receives a sound wave from the speaker 15 of the Tx node 10 (S220-Y), and the sound wave receiver 140 generates an interrupt using the received sound wave and forwards the interrupt to the processor 120 (S230-Y), the processor 120 wakes up the wireless sensor node 100 and lets the wireless sensor node 100 enter a reception standby state (S240).

The interrupt is generated in operation S230 when there is a sound signal filtered by the filter 141 of the sound waver receiver 140 and output. The sound signal filtered and output by the filter 141 is a sound signal of a unique frequency band that is allocated to the wireless sensor node 100 and is a sound signal that is output through the speaker 15 from the Tx node 10 which intends to wake up the wireless sensor node 100.

In operation S240, power is supplied to the RF transceiver 130. Accordingly, the processor 120 receives data from the Tx node 10 through the RF transceiver 130 (S250). In order to receive data in operation S250, the RF transceiver 130 communicates with the Tx node 10 according to a carrier sense multiple access-collision avoidance (CSMA-CA), time division multiple access (TDMA), frequency division multiple access (FDMA), or code division multiple access (CDMA) method.

The process of waking up the wireless sensor node 10 by the Tx node 10 and receiving data when the wireless sensor node 10 is operated in the sleep state has been described so far with reference to FIG. 2.

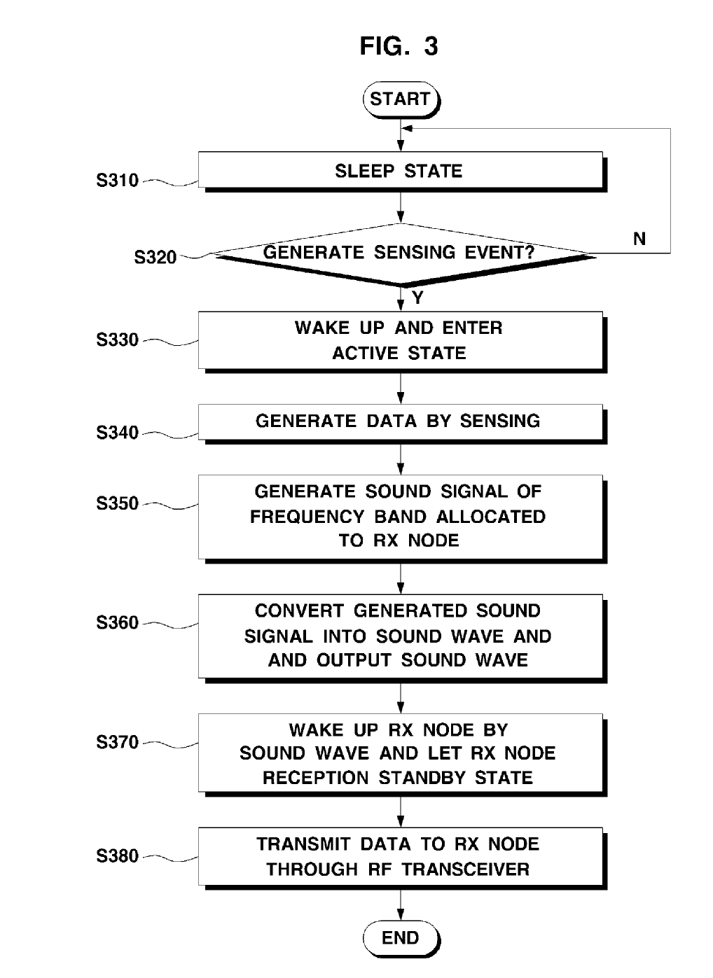

Hereinafter, a process of waking up the Rx node 20 by the wireless sensor node 100 and transmitting data to the Rx node 20 when the Rx node 20 is operated in a sleep state will be explained in detail with reference to FIG. 3.

FIG. 3 is a flowchart to explain a process of transmitting data of the wireless sensor node 100 of FIG. 1.

As shown in FIG. 3, in order to reduce consumption of a limited battery, the wireless sensor node 100 is operated in a sleep state (S310).

When an sensing event is generated in such a sleep mode (S320-Y), the processor 120 wakes up the wireless sensor node 100 and lets the wireless sensor node 100 enter an active state (S330). The sensing event generated in operation S320 refers to the advent of a sensing period or a sensing interrupt caused by an external command.

When the wireless sensor node 100 is woken up, power is supplied to the sensor 10 and the sensor 10 generates data by sensing (S340).

The processor 120 generates a sound signal of a frequency band allocated to the Rx node 20 (S350), and the sound wave transmitter 150 converts the sound signal which is generated in operation S350 into a sound wave and outputs the sound wave (S360).

The microphone 25 of the Rx node 20 receives the sound wave which is output in operation S360, and the Rx node 20 is woken up by this sound wave and enters a reception standby state.

After that, the processor 120 transmits the data which is generated in operation S340 to the Rx node 20 through the RF transceiver 130 (S380). In order to transmit the data in operation S380, the RF transceiver 130 communicates with the Rx node 10 according to a CSMA-CA, TDMA, FDMA, or CDMA method.

The process of controlling wake-up using the sound wave and exchanging data in the wireless sensor network with low power has been described so far.

In FIG. 2, the wireless sensor node 100 which has received data from the Tx node 10 may enter an active state and may perform the transmitting process of FIG. 3.

Furthermore, in FIG. 2, the wireless sensor node 100 which has received data from the Tx node 10 may enter an active state, and may generate data using its own sensor 110 and may perform the transmitting process of FIG. 3 with the generated data and the received data.

Also, in the above exemplary embodiment, it is assumed that data transmission is performed by 1:1. However, data transmission may be performed by 1:N. To achieve this, the wireless sensor node 100 may output a sound wave of a frequency band to wake up a plurality of wireless sensor nodes at the same time and wake up the wireless sensor nodes, and then may transmit data.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A wireless device comprising:
a sound wave receiver which receives a sound wave output from a first external device, converts the sound wave into an electric sound signal, and outputs an interrupt;
an RF transceiver which RF-communicates with the first external device; and
a processor which, when the interrupt is received from the sound wave receiver in a sleep state, is woken up and receives data from the first external device through the RF transceiver.

2. The wireless device as claimed in claim 1, wherein the sound wave receiver comprises:
a microphone which receives the sound wave output from the first external device and converts the sound wave into a sound signal;
an amplifier which amplifies the sound signal which is output from the microphone; and
a filter which filters a specific frequency band from the sound signal amplified by the amplifier, and outputs the specific frequency band as an interrupt.

3. The wireless device as claimed in claim 2, wherein the specific frequency band is a frequency band that is allocated to wake up the wireless device.

4. The wireless device as claimed in claim 1, further comprising a sound wave transmitter which converts an input sound signal into a sound wave, and outputs the sound wave,
wherein the processor forwards the sound signal of a frequency band to wake up a second external device, which is in a sleep state, to the sound wave transmitter, and when the second external device is woken up, transmits data to the second external device through the RF transceiver.

5. The wireless device as claimed in claim 4, further comprising a sensor which generates data by sensing,
wherein, when a sensing period arrives in a sleep state, the processor generates sensing data by operating the sensor, forwards the sound signal to the sound wave transmitter, and transmits the sensing data to the second external device through the RF transceiver.

6. The wireless device as claimed in claim 4, further comprising a sensor which generates data by sensing,
wherein, when the interrupt is received from the sound wave receiver, the processor is woken up, generates sensing data by operating the sensor, forwards the sound signal to the sound wave transmitter, and transmits the sensing data and the data received from the first external device to the second external device through the RF transceiver.

7. A wireless device comprising:
a sound waver transmitter which converts an input sound signal into a sound wave, and outputs the sound wave;
an RF transceiver which RF-communicates with an external device; and
a processor which forwards a sound signal of a specific frequency band to the sound wave transmitter to wake up the external device which is in a sleep state, and, when the external device is woken up, transmits data to the external device through the RF transceiver.

8. The wireless device as claimed in claim 7, wherein the specific frequency band is a frequency band that is allocated to wake up the external device.
